(19) United States
(12) Patent Application Publication
(10) Pub. No.: US 2015/0226905 A1
(43) Pub. Date: Aug. 13, 2015

(54) QUANTUM DOT CONTAINER, RELATED MANUFACTURING METHOD, AND RELATED DISPLAY DEVICE

(71) Applicant: SAMSUNG DISPLAY CO., LTD., Yongin-si (KR)

(72) Inventors: Sang-Hyuck YOON, Seoul (KR); Han-Moe CHA, Seoul (KR)

(21) Appl. No.: 14/608,021

(22) Filed: Jan. 28, 2015

(30) Foreign Application Priority Data
Feb. 7, 2014 (KR) 10-2014-0014163

(51) Int. Cl. F21V 8/00; F21V 9/16

(52) U.S. Cl. CPC G02B 6/0026; F21V 9/16; G02B 6/0065

(57) ABSTRACT

A quantum dot container may include a body that has a cavity and a hole. The hole may extend from the cavity to an outer surface of the body. The quantum dot container may further include a phosphor disposed inside the cavity. The quantum dot container may further include a sealing material disposed inside the hole.

### CROSS-REFERENCE TO RELATED APPLICATION

This application claims priority to and the benefit of Korean Patent Application No. 10-2014-0014163, filed on Feb. 7, 2014, with the Korean Intellectual Property Office, the disclosure of which is incorporated herein in its entirety by reference.

### BACKGROUND

1. Field

Embodiments of the present invention relate to a quantum dot container (e.g., a quantum dot filled tube), a manufacturing method of the quantum dot container, and a display device that includes the quantum dot container. The quantum dot container may be used for wavelength conversion.

2. Description of the Related Art

A display device, such as a liquid crystal display (LCD), may include a display panel for displaying an image and may include a backlight assembly for supplying light to the display panel. The backlight assembly may include a light source.

A set of substantially low-power high-efficiency light-emitting elements, such as light-emitting diodes (LEDs) may be used as a light source in a backlight assembly. The LED light source may emit blue light.

The display device may include a thin pipe-shaped container filled with quantum dots for converting the blue light container to white light. The display panel may receive the white light for exhibiting various colors through, for example, color filtering.

This quantum dot container may include a substantially long non- emission area or non-conversion portion that does not perform wavelength conversion. The non-emission area may require a substantially wide non-display bezel area of the display device. As a result, the size of the display device may be undesirably large.

### SUMMARY

Embodiments of the present invention may be related to a quantum dot container that may be used for wavelength conversion in a display device. The quantum dot container may have substantially short non-emission areas (or non-conversion portions). Advantageously, the display device may have a substantially narrow bezel width, such that the display device may be substantially space-efficient. Embodiments of the invention may be related to the display device, which includes the quantum dot container. Embodiments of the invention may be related to a manufacturing method of the quantum dot container.

An embodiment of the present invention may be related to a quantum dot container that may include a body that has a cavity and a hole. The hole may extend from the cavity to an outer surface of the body (such that the hole may directly connect to each of the cavity and the outer surface of the body). The quantum dot container may further include a phosphor disposed (e.g., filled) inside the cavity. The quantum dot container may further include a sealing material disposed (e.g., filled) inside the hole.

The body may include a first end portion and a second end portion. The cavity may be positioned between the first end portion and the second end portion in a first direction (e.g., the extension direction of the body aligned with the long axis of the body). The hole may be positioned inside (and enclosed/surrounded by) the second end portion. A length of the first end portion in the first direction may be substantially equal to a length of the second end portion in the first direction.

Each of the first end portion and the second end portion may contain no phosphor and may represent a non-emission area and/or non-conversion portion of the quantum dot container that does not perform wavelengh conversion.

A length of the second end portion in the first direction may be in a range of 2 mm to 5 mm.

An outer shape of the first end portion may be substantially identical to and/or may be substantially a mirror image of an outer shape of the second end portion.

The phosphor may include at least one of quantum dots, metal based sulfide, silicon, and nitride.

A diameter of the hole (in a direction perpendicular to the first dirction) may be in a range of 1.0 mm to 2.2 mm. A length of the hole (in the first direction) may be perpendicular to the diameter and may be less than or equal to 5 mm.

The sealing material may include a laser sensitive glass frit.

The sealing material may include one or more epoxy resins.

An embodiment of the preent invention may be related to a method for manufacturing a quantum dot container. The method may include the following steps: preparing a tube having a first open end, a second open end, and a hollow structure extending from the first open end to the second open end; sealing the first open end and sealing the second open end to form a body that has a first end portion, a second end portion, and a cavity positioned between the first end portion and the second end portion; forming a hole in (and/or through) the second end portion after the sealing the second open end, the hole extending from an outer surface of the body to the cavity; keeping the cavity in a substantially vacuum state; injecting a phosphor into the cavity through the hole when the cavity is substantially vacuum; and disposing (e.g., filling) a sealing material inside the hole.

A laser may be used in the step of forming the hole.

A diameter of the hole may be in a range of 1.0 mm to 2.2 mm. A length of the hole may be less than or equal to 5 mm.

The phosphor may include at least one of quantum dots, metal based sulfide, silicon, and nitride.

The sealing material may be formed of a laser sensitive glass frit.

The sealing material may be formed of one or more epoxy resins.

An embodient of the present invention may be related to a display device that may include a display panel for displaying one or more images according to one or more input signals, a light source, a light guide member overlapping the display panel and overlapping the light source, and a quantum dot container disposed between the light source and the light guide member for performing light wavelengh conversion. The quantum dot container may include a body having a cavity and a hole that extends from the cavity to an outer surface of the body, a phosphor disposed (e.g., filled) inside the cavity, and a sealing material disposed (e.g., filled) inside the hole.

The body may include a first end portion and a second end portion. The cavity may be positioned between the first end portion and the second end portion in a first direction (e.g., the extension direction of the body aligned with the long axis for the body). The hole may be positioned inside the second end portion. A length of the first end portion in the first direction may be substantially equal to a length of the second end portion in the first direction.

The display device may include a bezel that partially overlaps the display panel. Each of the first end portion and the second end portion may overlap the bezel in a second direction perpendicular to the first direction and may contain no phosphor.

A length of the hole in the first direction may be in a range of 2 mm to 5 mm.

The phosphor may include at least one of quantum dots, metal based sulfide, silicon, and nitride.

An embodiment of the present invention may be related to a quantum dot container that may include a tube having a hole that directly connects to each of an inner space and an outer surface of the tube, a phosphor filled inside the inner space of the tube, and a sealing material filled in the hole.

The tube may include two end portions having the same shape as each other.

The two end portions of the tube may be non- emission areas.

Each of the non-emission areas may have a length in a range of 2 mm and 5 mm.

The phosphor may include quantum dots.

The phosphor may include at least one of metal based sulfide, silicate, and nitride.

The hole may have a diameter in a range of 1.0 mm to 2.2 mm.

The sealing material may be a laser sensitive glass frit.

The sealing material may include one or more epoxy resins.

An embodiment of the present invention may be related to a method for manufacturing a quantum dot container. The method may include preparing an open-ended tube having a hollow formed therein, sealing both open ends of the open-ended tube to form a sealed tube that has an interior cavity, forming a hole in an end portion of the sealed tube, keeping the interior cavity of the sealed tube in a vacuum state, injecting a phosphor into the interior cavity of the sealed tube through the hole when the interior cavity is substantially vacuum, and filling the hole with a sealing material.

A laser may be used in the forming of the hole.

The hole may have a diameter in a range of 1.0 mm to 2.2 mm.

The phosphor may include at least one of quantum dots, metal based sulfide, silicon, and nitride.

The sealing material may be formed to be a laser sensitive glass frit.

The sealing material may be formed of one or more epoxy resins.

An embodiment of the present invention may be related to a display device that may include a display panel, a light source, a light guide plate overlapping the display panel in a first direction and overlapping the light source in a second direction, and a quantum dot container positioned between the light source and the light guide plate for performing light wavelength conversion. The quantum dot container may include a tube having a hole directly connected to each of an inner space and an outer surface of the tube, a phosphor filled in the tube, and a sealing material filled in the hole.

The tube may include two end portions having the same shape as each other.

The two end portions of the tube may be non-emission areas.

Each of the non-emission areas may have a length in a range of 2 mm to 5 mm.

The phosphor may include at least one of quantum dots, metal based sulfide, silicon, and nitride.

The foregoing summary is illustrative only and is not intended to be in any way limiting.

### BRIEF DESCRIPTION OF THE DRAWINGS

FIG. 1 is a schematic plan view illustrating a quantum dot container according to an embodiment of the present invention.

FIG. 2 is a schematic plan view illustrating a quantum dot container mounted in a display device according to an embodiment of the present invention.

FIG. 3 is a schematic plan view illustrating a quantum dot container according to an embodiment of the present invention.

FIGS. 4A to 4G are diagrams illustrating a method for manufacturing a quantum dot container according to an embodiment of the present invention.

FIG. 5 is an exploded perspective view illustrating a display device including a quantum dot container according to an embodiment of the present invention.

### DETAILED DESCRIPTION

Hereinafter, embodiments of the present invention are described with reference to the accompanying drawings.

Example embodiments of the present invention are illustrated in the accompanying drawings and described in the specification. The scope of the present invention is not limited to the example embodiments and should be construed as including all potential changes, equivalents, and substitutions to the example embodiments.

In the specification, when a first element is referred to as being “connected” to a second element, the first element may be directly connected to the second element or indirectly connected to the second element with one or more intervening elements interposed therebetween. The terms “comprises,” “comprising,” “includes,” and/or “including,” when used in this specification, may specify the presence of stated features, integers, steps, operations, elements, and/or components, but do not preclude the presence or addition of one or more other features, integers, steps, operations, elements, and/or components.

Although the terms “first,” “second,” and “third” and the like may be used herein to describe various elements, these elements should not be limited by these terms. These terms may be used to distinguish one element from another element. Thus, “a first element” could be termed “a second element” or “a third element,” and “a second element” and “a third element” can be termed likewise without departing from the teachings herein. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-type (or first-set),” “second-type (or second-set),” etc., respectively.

Like reference numerals may refer to like elements in the specification.

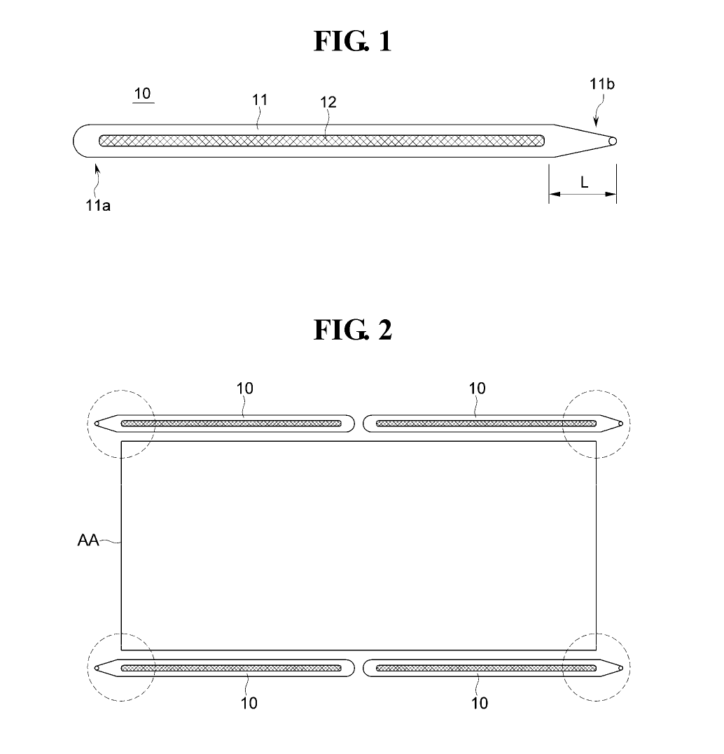

FIG. 1 is a schematic plan view illustrating a quantum dot container 10 according to an embodiment of the present invention. The quantum dot container 10 may have one or more features that may be analogous to or substantially identical to one or more features of a conventional quantum dot filled tube.

Referring to FIG. 1, the quantum dot container 10 includes a glass tube 11 and a phosphor 12 sealed in the glass tube 11.

The glass tube 11 may seal the phosphor 12 and may prevent infiltration of moisture. The glass tube 11 may have a polygonal or oval cross-section.

The phosphor 12 is injected into the glass tube 11 that is in a vacuum state. The phosphor 12 is a substance that changes a wavelength of light. For example, the phosphor 12 can change a wavelength of blue light emitted from a blue LED light source so that energy of the blue light can be converted to white light.

The phosphor 12 may include quantum dots. The phosphor 12 may further include at least one of sulfide, silicon, and metal element-based nitride.

A quantum dot is a wavelength conversion particle that converts a wavelength of light so as to emit specific light. Quantum dots with different particle sizes convert different wavelengths. Therefore, light of a desired color can be emitted by adjusting a diameter of a quantum dot.

The phosphor 12 may include a green conversion particle and a red conversion particle, which may be quantum dots. The green conversion particle has a smaller diameter than the red conversion particle.

The quantum dot may generate a much stronger fluorescence effect than a general phosphor in a small wavelength range. The quantum dot may have semiconductor particles, such as one or more particles of CdSe, CdTe, CdS, and the like that are composed of nano-sized elements of groups II-IV in the core of the quantum dot.

For example, the quantum dot particle has a diameter in a range of 2 nm to 10 nm, and the particle size may be adjustable where necessary.

In the case where the quantum dot has a small diameter, a wavelength of emitted light becomes shorter such that blue-based light is generated. In contrast, when the size of the quantum dot increases, the wavelength of emitted light becomes longer such that red-based light is generated.

The quantum dot may have a dual structure including an inner core and an outer shell surrounding the inner core. For instance, the quantum dot composed of CdSe and ZnS may include an inner core made of CdSe and an outer shell made of ZnS.

Wavelength conversion of light may depend on the sizes of the quantum dots. For example, light emitted from a blue LED light source passes through the quantum dots. The light passing through a small-sized quantum dot is converted to green light, the light passing through a large-sized quantum dot is converted to red light, and the light traveling between the two quantum dots is not converted and remains a blue light having.

Thus, these three colors of light of red R, green G, and blue B are mixed so that white light is produced. In an embodiment, the quantum dot with a small diameter may be a green conversion particle, and the quantum dot with a large diameter may be a red conversion particle.

Hereinafter, a manufacturing method for the quantum dot container 10 is described.

A glass tube 11 having a polygonal or oval cross-section is prepared. A first end portion of the glass tube 11 is heated to be sealed (in a first sealing process). Subsequently, air inside the glass tube 11 is removed through a second end portion, which is open, so that the glass tube 11 is in a vacuum state. In an embodiment, an air pump may be used for air exhaustion.

Next, the phosphor 12 is injected into the glass tube, which is in a vacuum state, using nitrogen gas N₂, and heat is applied to the second end portion to seal the second end portion (in a second sealing process).

As described above, the inside of the glass tube 11 has been in a vacuum state before the phosphor 12 is injected; therefore, oxidation of the phosphor 12 may be prevented. That is, there should be substantially no water H₂O and oxygen O₂ inside the glass tube 11.

In the first and second sealing processes, oxygen may be used to generate a high-temperature (˜200° C.) flame for sealing the glass tube 11 by applying the flame to melt glass material.

Oxygen should not infiltrate into the glass tube 11 in the second sealing process when the glass tube 11 is maintained to be in a vacuum state.

The first sealing process is performed before the phosphor 12 is injected. The glass tube 11 is sealed by instantaneously applying a high-temperature flame to melt glass material. As a result, as illustrated in FIG. 1, the first end portion 11a of the glass tube 11 can be sealed in a natural form (with a relatively thin glass wall) by the first sealing process.

The second sealing process is performed after the phosphor 12 has been injected, such that the second sealing process should not be performed using a high-temperature flame. Instead, heat is gradually applied for sealing the glass tube 11 in the second sealing process. Consequently, as illustrated in FIG. 1, the second end portion 11b of the glass tube 11 may have a thicker or longer glass portion than the first end portion 11a.

A length L of the elongated glass portion of the second end portion 11b may be about 12 mm as a result of the second sealing process. This second end portion 11b may become a non-emission area (or non-conversion portion) because the phosphor 12 is not filled in the second end portion 11b. The second end portion 11b of the quantum dot container 10 represent a non-emission area (or non-conversion portion) of the quantum dot container 10.

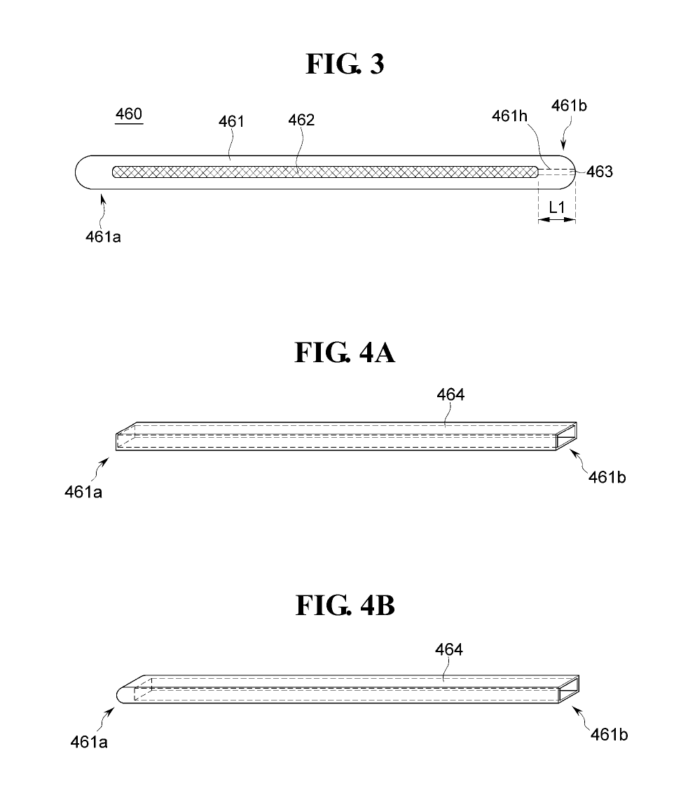

FIG. 2 is a schematic plan view illustrating a quantum dot container mounted in a display device according to an embodiment of the present invention.

Referring to FIG. 2, four quantum dot containers 10 are disposed at upper and lower portions of an active area AA (or display area) of the display device. The active area AA may be configured to display images according to image signals provided to the display device. In embodiments of the invention, positions and the number of the quantum dot containers 10 may be configured, for example, according to the size of the active area AA.

Referring to FIG. 2, the quantum dot container 10 does not include the phosphor 12 in the non-emission area (or non-conversion portion), and thus the non-emission area should be disposed outside the active area AA. The non-emission area may be covered by a bezel, which should have a sufficient width, for substantially hiding the non-emission area.

The quantum dot container 10 may be sealed to have a non-emission area with a length L of about 10 mm to about 12 mm in order to prevent oxygen or moisture infiltration that may occur when the second sealing process is performed. The bezel width may be about 10 mm or more.

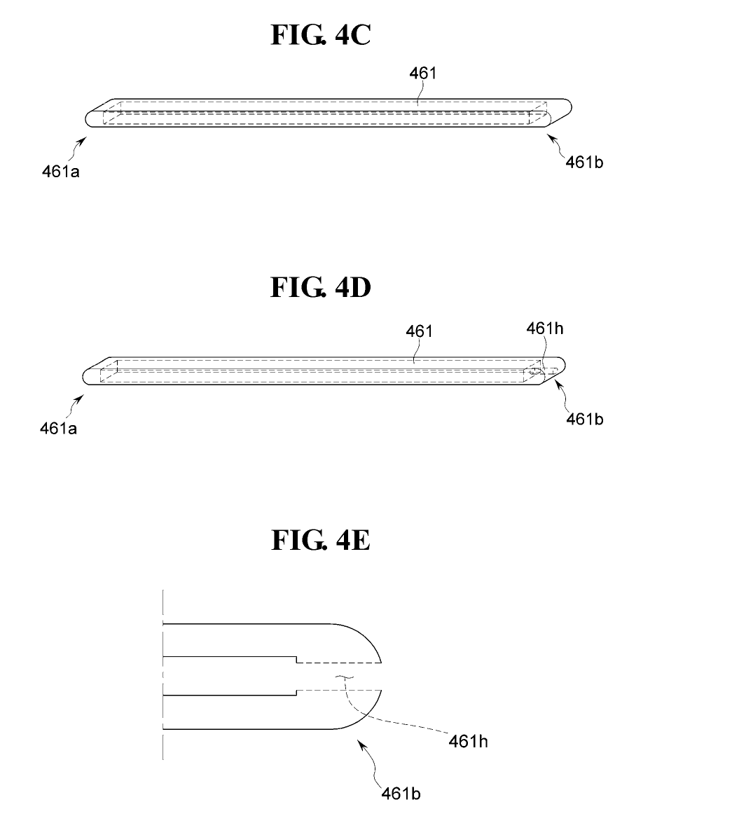

FIG. 3 is a schematic plan view illustrating a quantum dot container 460 according to an embodiment of the present invention. The quantum dot container 460 may have one or more elements and/or features that are substantially identical to or analogous to one or more elements and/or features of the quantum dot container 10 described with reference to FIG. 1 and FIG. 2. Descriptions for the identical or analogous elements may not be repeated.

Referring to FIG. 3, the quantum dot container 460 includes a glass body 461 having a cavity structure surrounded by an inner surface of the glass body 461 and includes a through-hole structure 461h (or passage structure) that extends from the cavity to an outer surface of the glass body 461. The quantum dot container 460 may further include a phosphor 462 disposed and/or filled inside the cavity of the glass body 461. The quantum dot container 460 may further include a sealing material 463 disposed and/or filled inside the hole structure 461h. The sealing material 463 may include at least one of laser sensitive glass frit and epoxy resin.

The quantum dot container 460 has two end portions that may have shapes different from end portion shapes of the glass tube 11 of the quantum dot container 10 illustrated in FIG. 1.

In an embodiment, two end portions 461a and 461b of the quantum dot container 460 may have substantially the same shape.

The non-conversion portion of the quantum dot container 460 may have a length L1 in a range of about 2 mm to about 5 mm. The length of the hole structure 461h and/or the length of the second end portion 461b may be substantially equal to the length L1 of the non-conversion portion of the quantum dot container 460.

Given the relatively short length of the non-conversion portion of the quantum dot container 460, the bezel width of the display device that includes the quantum dot container 460 may be satisfactorily small.

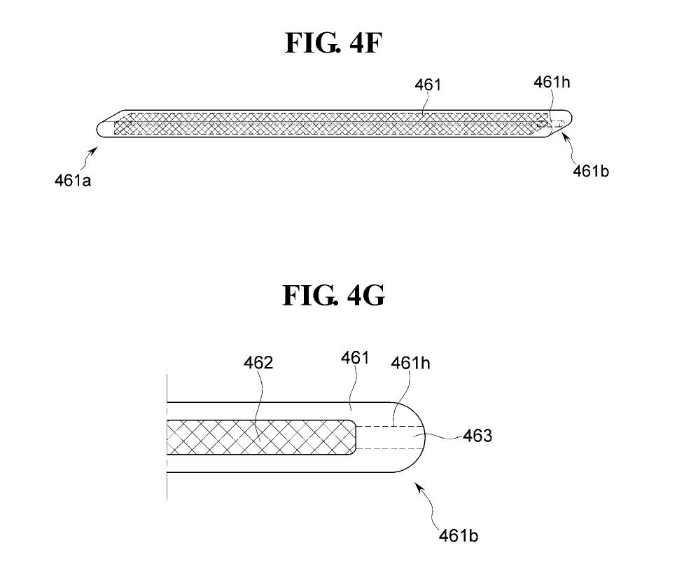

FIGS. 4A to 4G are diagrams illustrating a method for manufacturing the quantum dot container 460 according to an embodiment of the present invention.

The method includes preparing a glass tube 464 that has two open ends and a hollow structure extending between the two open ends, sealing two end portions 461a and 461b of the glass tube 461 to form a glass body 461 that encloses a cavity, forming a hole 461h through the second portion 461b of the glass body 461, filling the cavity inside the glass body 461 with the phosphor 462 through the hole 461h, and sealing the hole 461h using the sealing material 463.

Referring to FIG. 4A, the glass tube 464 is prepared for manufacturing the quantum dot container 460. The glass tube 464 may be formed of a light transmissive material such as light transmissive glass or transparent glass. For example, the glass tube 461 may include at least one of soda lime and borosilicate.

In an embodiment, referring to FIG. 4A, a cross-section of the glass tube 464 is quadrangular in shape. In embodiments of the present invention, the cross-section of the glass tube 461 may have one or more of a variety of shapes, such as a circle, a polygon, a round quadrilateral, and an oval.

Next, referring to FIGS. 4B and 4C, a first end portion 461a of the glass tube 464 is sealed (the first sealing), and simultaneously or subsequently a second end portion 461b of the glass tube 464 is sealed (the second sealing), such that the glass body 461 may be formed. As an example of a method for sealing the two end portions 461a and 461b of the glass tube 464, heat with a temperature higher than the melting point of the glass material of the glass tube 464 is applied to melt the end portions 461a and 461b of the glass tube 461.

In an embodiment, the sealing processes of both the end portions 461a and 461b of the glass tube 464 is performed before the quantum dot filling process. Advantageously, the length of the non-emission area (or non-conversion portion) of the quantum dot container 460 may be minimized.

According to an embodiment of the present invention, the sealing process for each end portion may be performed before the cavity inside the glass body 461 is in a vacuum state, and thus both the end portions 461a and 461b of the glass tube 464 can be sealed by instantaneously applying high-temperature flame. Given the short heat-application time, deformation and/or elongation of the end portions may be minimized, such that the length L1 of the non-conversion portion of the quantum dot container 460 may be minimized.

Because both the end portions 461a and 461b of the glass tube 464 can be sealed before the cavity inside the glass body 461 is filled with the phosphor, the length of the non-conversion portion of the quantum dot container 460 can be minimized.

Next, referring to FIG. 4D and FIG. 4E, the hole 461h is formed through the second end portion 461b of the glass body 461.

According to an embodiment of the present invention, the hole 461h in the glass body 461 may be formed in at least one end portion of the glass tube 461. In an embodiment, the hole 461h may be formed through a different portion of the glass body 461.

According to an embodiment of the present invention, the hole 461h may be formed using laser.

The hole 461h may have a diameter in a range of 1.0 mm to 2.2 mm.

Referring to FIG. 4F, the cavity inside the glass body 461 is in a vacuum state obtained and/or maintained through the hole 461h, and then the phosphor 462 is injected into the cavity.

In an embodiment, an air pump may be used to maintain the vacuum state of the cavity of the glass body 461. Next, the phosphor 462 is injected into the vacuum cavity inside the glass body 461 using nitrogen gas (N₂). As described above, the vacuum state of the cavity inside the glass tube 461 is achieved before the phosphor 12 is injected, so that oxidation of the phosphor 462 may be prevented.

Referring to FIG. 4G, after the injection of the phosphor 462 is completed, the hole 461h of the glass body 461 is filled with a sealing material 463.

In order to fill the hole 461h of the glass body 461, laser sensitive low-temperature frit glass or epoxy resins may be employed.

In an embodiment, a laser sensitive low-temperature frit glass is used for sealing the hole 461h, wherein the hole 461h of the glass body 461 is filled with the laser sensitive low-temperature frit glass, and then laser is irradiated to the laser sensitive low-temperature frit glass.

In an embodiment, an epoxy resin is used to seal the hole 461h, wherein a water resistant epoxy resin is injected into the hole 461h of the glass body 461 in order to completely fill empty spaces inside the hole 461 and/or the glass body 461.

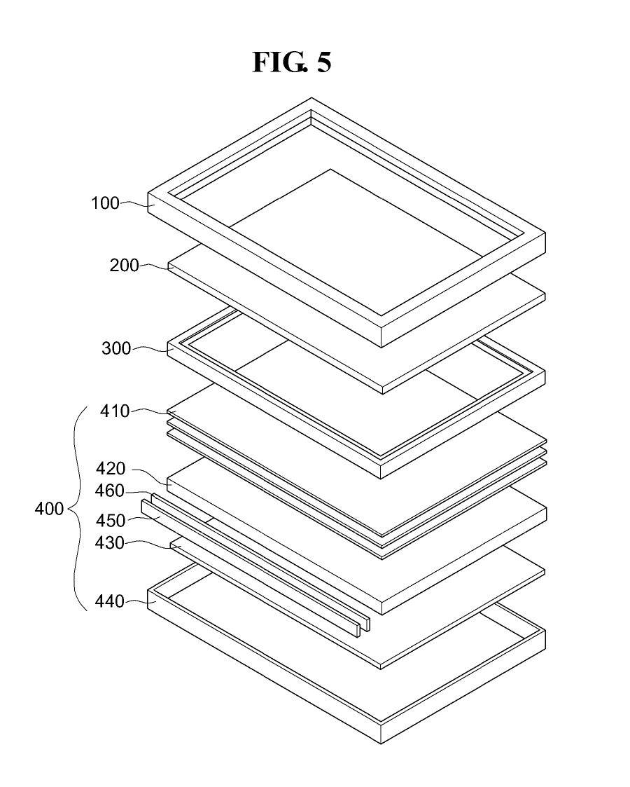

FIG. 5 is an exploded perspective view illustrating a display device according to an embodiment of the present invention.

Referring to FIG. 5, the display device includes a display panel 200 (e.g., a liquid crystal display panel 200) configured to display an image according to an input signal, a backlight assembly 400 configured to supply light to the display panel 200, a top case 100 provided to cover the display panel 200, and a mold frame 300 configured to connect the top case 100 to a bottom case 440 and to support the display panel 200.

The mold frame 300 is coupled to the bottom case 440 and accommodates the display panel 200. The mold frame 300 may be formed of a flexible material, such as plastic, in order to absorb impact and protect the display panel 200.

The top case 100 is coupled to the mold frame 300 and the bottom case 440 so as to cover the display panel 200 seated on the mold frame 300. The top case 100 has an open window (which may be positioned in the middle of the top case 100) to expose the active area AA (or display area) of the display panel 200. The top case 100 may include a bezel that may cover and/or overlap a non-active area of the display panel 200 that surrounds the active area AA of the display panel. Each of end portions 461a and 461b of the quantum dot container 460 may overlap the bezel in a direction perpendicular to the extension direction of the quantum dot container 460. The phosphor 462 and/or the phosphor-container cavity of the body 461 may be positioned between the first end portion 461a and the second end portion 461b in the extension direction of the quantum dot container 460. A length of the first end portion 461a may be equal to a length of the second end portion 461b in the extension direction of the quantum dot container 460

The top case 100 may be connected to the mold frame 300 and the bottom case 440 by hooks and/or screws. The top case 100 and the bottom case 440 can be coupled to each other through one or more of a variety of methods and/or mechanisms.

The backlight assembly 400 includes an optical sheet 410, a light guide plate 420, a reflective sheet 430, a bottom case 440, a light source unit 450, and a quantum dot container 460.

The light source unit 450 may be disposed at a corner or on a side of the light guide plate 420. The light source unit 450 may emit light toward a light incident surface at a corner portion or a side surface of the light guide plate 420.

The light source 450 may include at least one LED chip (not shown) and a package (not shown) for accommodating the LED chip.

A light source unit 450 may be formed on one side surface, each of two side surfaces, or each of four side surfaces of the light guide plate 420. A light source 450 may be formed on at least one edge of the light guide plate 420. One or more light sources 450 may be deployed in consideration of the size, the brightness uniformity requirements, and/or other factors associated with the display panel 200.

Light emitted from the light source unit 450 is incident toward at least one incident surface of the light guide plate 420. The light guide plate 420 may substantially uniformly supply light (from a surface other than the incident surface) toward the display panel 200.

The light guide plate 420 is disposed close to the light source unit 450 and is accommodated in the bottom case 440. The light guide plate 420 may be provided in the form of, for example, a quadrilateral plate having a footprint as large as a footprint of the display panel 200. In embodiments of the present invention, the light guide plate 420 may have one or more of various shapes and/or may include predetermined grooves, protrusions, and/or other structures according to the position(s) of the light source(s).

The light guide plate 420 may be a plate, a sheet, or a film and may facilitate slimness of display devices.

The light guide plate 420 may be formed of a light-transmissive material such as, for example, an acrylic resin such as polymethylmethacrylate (PMMA) or polycarbonate (PC) so as to guide light efficiently.

A pattern may be formed on at least one surface of the light guide plate 420. For example, on a lower surface, a scattering pattern (not shown) may be formed so as to scatter and/or reflect the guided light upwards.

The optical sheet 410 is disposed on an upper portion of the light guide plate 420. The optical sheet 410 may diffuse and/or collect light transmitted from the light guide plate 420.

The optical sheet 410 may include one or more of a diffusion sheet, a prism sheet, a protective sheet, and/or one or more other functional sheets.

The diffusion sheet may disperse light incident from the light guide plate 420 so as to prevent the light from being partly concentrated.

The prism sheet may include prisms having a triangular cross-section and formed in a predetermined array on one surface of a base film. This prism sheet is disposed on the diffusion sheet and thus may collect light diffused from the diffusion sheet in a direction perpendicular to the display panel 200.

The protective sheet may be formed on the prism sheet. The protective sheet serves to protect a surface of the prism sheet and to diffuse light to make light distribution uniform.

The reflective sheet 430 is disposed between the light guide plate 420 and the bottom case 440, so that light emitted downwards from the light guide plate 420 is reflected toward the display panel 200, thereby increasing light efficiency.

The reflective sheet 430 may be formed of, for example, polyethylene terephthalate (PET) so as to possess reflectance property. One surface of the reflective sheet may be coated with a diffusion layer containing, for example, titanium dioxide. In an embodiment, the reflective sheet 430 may be formed of a material containing a metal, such as silver (Ag).

The bottom case 440 may accommodate the reflective sheet 430 and the light guide plate 420. A bottom surface of the bottom case 440 is formed parallel to the light guide plate 420.

The bottom case 440 may be formed of a metal material having rigidity, such as stainless steel, or a material having good heat dissipation properties, such as aluminum or an aluminum alloy. The bottom case 440 is responsible for maintaining a framework of the display device and protecting a variety of components accommodated therein.

In order to realize white light with high color reproducibility, the quantum dot container 460 is disposed between the light source unit 450 and the light guide plate 420.

According to an embodiment of the present invention, a length of a non-emission area (or non-conversion portion) of the quantum dot container 460 may be substantially small. Advantageously, the display device may have a satisfactorily narrow bezel, such that the display device may be satisfactorily space efficient.

As can be appreciated from the foregoing, various embodiments of the present invention have been described herein for purposes of illustration. Various modifications may be made without departing from the scope and spirit of the present invention defined by the following claims and equivalents of the claims.

What is claimed is:

1. A quantum dot container comprising:
a body having a cavity and a hole, the hole extending from the cavity to an outer surface of the body;
a phosphor disposed inside the cavity; and
a sealing material disposed inside the hole.

2. The quantum dot container of claim 1, wherein the body comprises a first end portion and a second end portion, wherein the cavity is positioned between the first end portion and the second end portion in a first direction, wherein the hole is positioned inside the second end portion, and wherein a length of the first end portion in the first direction is equal to a length of the second end portion in the first direction.

3. The quantum dot container of claim 2, wherein each of the first end portion and the second end portion contains no phosphor.

4. The quantum dot container of claim 3, wherein a length of the second end portion is in a range of 2 mm to 5 mm.

5. The quantum dot container of claim 2, wherein an outer shape of the first end portion is identical to an outer shape of the second end portion.

6. The quantum dot container of claim 1, wherein the phosphor comprises at least one of quantum dots, metal based sulfide, silicon, and nitride.

7. The quantum dot container of claim 1, wherein a diameter of the hole is in a range of 1.0 mm to 2.2 mm, and wherein a length of the hole is perpendicular to the diameter and is less than or equal to 5 mm.

8. The quantum dot container of claim 1, wherein the sealing material comprises a laser sensitive glass frit.

9. The quantum dot container of claim 1, wherein the sealing material comprises one or more epoxy resins.

10. A method for manufacturing a quantum dot container, the method comprising:
preparing a tube having a first open end, a second open end, and a hollow structure extending from the first open end to the second open end;
sealing the first open end and sealing the second open end to form a body that has a first end portion, a second end portion, and a cavity positioned between the first end portion and the second end portion;
forming a hole in the second end portion after the sealing the second open end, the hole extending from an outer surface of the body to the cavity;
injecting a phosphor into the cavity through the hole when the cavity is substantially vacuum; and
disposing a sealing material inside the hole.

11. The method of claim 10, wherein a laser is used in the forming the hole.

12. The method of claim 10, wherein a diameter of the hole is in a range of 1.0 mm to 2.2 mm, and a length of the hole is less than or equal to 5 mm.

13. The method of claim 10, wherein the phosphor comprises at least one of quantum dots, metal based sulfide, silicon, and nitride.

14. The method of claim 10, wherein the sealing material is formed of a laser sensitive glass frit.

15. The method of claim 10, wherein the sealing material is formed of one or more epoxy resins.

16. A display device comprising:
a display panel configured to display an image;
a light source;
a light guide member overlapping the display panel and overlapping the light source; and
a quantum dot container disposed between the light source and the light guide member,
wherein the quantum dot container comprises:
a body having a cavity and a hole, the hole extending from the cavity to an outer surface of the body;
a phosphor disposed inside the cavity; and
a sealing material disposed inside the hole.

17. The display device of claim 16, wherein the body comprises a first end portion and a second end portion, wherein the cavity is positioned between the first end portion and the second end portion in a first direction, wherein the hole is positioned inside the second end portion, and wherein a length of the first end portion in the first direction is equal to a length of the second end portion in the first direction.

18. The display device of claim 17, further comprising a bezel that partially overlaps the display panel, wherein each of the first end portion and the second end portion overlaps the bezel in a second direction perpendicular to the first direction and contains no phosphor.

19. The display device of claim 16, wherein a length of the hole is in a range of 2 mm to 5mm.

20. The display device of claim 16, wherein the phosphor comprises at least one of quantum dots, metal based sulfide, silicon, and nitride.
